(19) United States
(12) Patent Application Publication
(10) Pub. No.: US 2011/0229643 A1
(43) Pub. Date: Sep. 22, 2011

(54) INK SET

(75) Inventor: Naotaka WACHI, Ashigarakami-gun (JP)

(73) Assignee: FUJIFILM Corporation, Tokyo (JP)

(21) Appl. No.: 13/050,713

(22) Filed: Mar. 17, 2011

(30) Foreign Application Priority Data
Mar. 18, 2010 (JP) 2010-062182

(51) Int. Cl. B05D 3/02; C09D 11/02; C09D 11/10; B05D 1/02

(52) U.S. Cl. 427/314; 106/31.13; 524/612; 106/31.9

(57) ABSTRACT

An ink set containing at least one ink of which viscosity at 70° C. is 100 mPa·s or more, and at least one ink of which color hue is the same as the above ink and of which viscosity at 70° C. is 30 mPa·s or less.

### FIELD OF THE INVENTION

The present invention relates to an ink set and an ink jet recording method using the same.

### BACKGROUND OF THE INVENTION

The ink jet recording has such a lot of advantages that a high-speed recording is possible; a low noise level is achieved; colorization is easy; a high resolution can be made; and a plain paper recording is possible. Because of these advantages, instruments and equipments using such recording method are remarkably in widespread use. As the ink used in this recording method, an aqueous ink is dominant from the viewpoints of safety, odor and the like. In the ink jet recording method, image formation is performed by ejecting (discharging) the ink in a rate of several thousands or more drops per second.

In the case where a high-speed printing is performed by the ink jet recording method, aggregation and color bleeding may occur. Specifically, the term “aggregation” signifies a phenomenon in which before absorption of the first ink droplet into a paper has been completed, the second ink droplet reaches to the first ink droplet and they are united or aggregated to form one large liquid droplet. The image resolution is deteriorated by the aggregation. On the other hand, the term “color bleeding” signifies a phenomenon in which image sharpness and color quality are deteriorated on the grounds that two droplets, which are to be united, contain a colorant having a different color from each other.

As a method contemplated to address the problem of color bleeding in a high-speed printing, a method of using an ink that turns into a gel in response to heat, and printing the ink on a recording element (paper) having been heated at a higher temperature than that of the ink is proposed (see JP-A-2003-285532 (“JP-A” means unexamined published Japanese patent application)). Further, in order to resolve bleeding and color bleeding as well as to form a highly coloring image, an ink-jet aqueous ink containing a thermoreversible thickening polymer is proposed (see JP-A-9-39381).

In the mean time, improvement of bleeding and suppression of penetration of the ink through the paper (transfer of the ink to the back side of the paper) have been further strongly required for the ink-jet recording pigment ink. The present inventors have confirmed that although the color bleeding is improved by techniques described in JP-A-2003-285532 and JP-A-9-39381, the effect of improvement is not enough. Further, in the case where images are formed using the above-described high-temperature-gelling ink, there is such a feature that voids tend to be formed among dots in a high-density region. As a result, an optical density (OD) necessary for the image is difficult to be obtained. A cloud is caused in the high-density region of the image by the voids among dots. In addition, image qualities such as granularity (graininess) are affected by the voids among dots.

### SUMMARY OF THE INVENTION

The present invention resides in an ink set, comprising:

at least one ink of which viscosity at 70° C. is 100 mPa·s or more; and

at least one ink of which color hue is the same as that of the above ink and of which viscosity at 70° C. is 30 mPa·s or less.

Further, the present invention resides in an ink set, comprising:

at least one ink which thickens in response to heating; and

at least one ink of which color hue is the same as that of the said ink and which does not substantially thicken in response to heating.

Further, the present invention resides in an ink jet recording method, comprising the step of printing on a recording sheet by ejecting ink droplets from an orifice of a recording head in response to recording signals,

wherein the ink droplets are ejected from the recording head using the ink set described in any one of the above items, and

wherein the recording sheet is heated at 70° C. or higher before the ink droplets land on the recording sheet or at the time of landing thereof.

Other and further features and advantages of the invention will appear more fully from the following description.

### DETAILED DESCRIPTION OF THE INVENTION

According to the present invention, there are provided the following means:

(1) An ink set, comprising:

at least one ink of which viscosity at 70° C. is 100 mPa·s or more; and

at least one ink of which color hue is the same as that of the above ink and of which viscosity at 70° C. is 30 mPa·s or less.

(2) The ink set described in the above item (1), wherein the ink of which viscosity at 70° C. is 100 mPa·s or more comprises a heat-sensitive material that gels at a high temperature.
(3) The ink set described in the above item (1) or (2), wherein the heat-sensitive material comprises a block polymer having an ethylene oxide moiety and a propylene oxide moiety.
(4) The ink set described in the above item (1) or (2), wherein the heat-sensitive material is a water-soluble cellulose ether compound.
(5) The ink set described in any one of the above items (1) to (4), comprising:

at least an ink of which color hue is black and of which viscosity at 70° C. is 100 mPa·s or more; and

at least one ink of which color hue is black and of which viscosity at 70° C. is 30 mPa·s or less.

(6) The ink set described in the above item (5), wherein a carbon black-based pigment is used as a colorant of the ink of which color hue is black.
(7) An ink set, comprising:

at least one ink which thickens in response to heating; and

at least one ink of which color hue is the same as that of the said ink and which does not substantially thicken in response to heating.

(8) The ink set described in any one of the above items (1) to (7), wherein a viscosity at 25° C. of each of inks in the ink set is 10 mPa·s or less.
(9) The ink set described in any one of the above items (1) to (8), comprising at least a yellow hue ink, a magenta hue ink, a cyan hue ink, and a black hue ink.
(10) An ink-jet recording method, comprising the step of printing on a recording sheet by ejecting ink droplets from an orifice of a recording head in response to recording signals,

wherein the ink droplets are ejected from the recording head using the ink set described in any one of the above items (1) to (9), and

wherein the recording sheet is heated at 70° C. or higher before the ink droplets land on the recording sheet or at the time of landing thereof.

(11) The ink-jet recording method described in the above item (10), wherein the recording head is of a piezo-type.

Hereinafter, the ink set of the present invention will be described.

### [Ink Set]

The ink set of the present invention contains at least two kinds of inks having the same hue to each other. Of the at least two kinds of inks having the same hue, at least one ink has viscosity at 70° C. of 100 mPa·s or more, and at least one other ink has viscosity at 70° C. of 30 mPa·s or less. It is sufficient that the ink set contains inks having at least one color hue in the above-described combination of inks. In a case in which the ink set contains an ink having another hue in addition to the above-described inks, it is sufficient that the ink having another hue is one or more kinds of inks. As the ink having another hue, an ink of which viscosity is 100 mPa·s or more may be contained, or an ink of which viscosity at 70° C. is 30 mPa·s or less may be contained, or alternatively both of them may be contained. However, from the viewpoint of suppressing penetration of the ink through the paper, it is preferable that at least the ink of which viscosity at 70° C. is 100 mPa·s or more is contained with respective to each hue.

In addition, of the at least two kinds of inks having the same color hue to each other that are contained in the ink set of the present invention, at least one is an ink which thickens (increases viscosity) in response to heating, and another is an ink which does not substantially thicken in response to heating. The phrase “thickens in response to heating” signifies that the difference in ink viscosity between at 25° C. and at 70° C. is 70 mPa·s or more. On the other hand, the phrase “does not substantially thicken in response to heating” signifies that the difference in ink viscosity between at 25° C. and at 70° C. is 5 mPa·s or less.

In the ink set of the present invention, it is preferred that the ink set contains at least one ink of which color hue is black and of which viscosity at 70° C. is 100 mPa·s or more, and an ink of which color hue is black and of which viscosity at 70° C. is 30 mPa·s or less. Further, it is preferred that the ink set has at least each color hue of yellow, magenta, cyan and black.

Hereinafter, the ink which is used in the present invention, of which viscosity at 70° C. is 100 mPa·s or more, and which thickens in response to heating is referred to as “a high-temperature gelling ink”.

In the case of performing the ink-jet recording using the high-temperature gelling ink, after increase of viscosity due to gel transition on a heated recording sheet, evaporation of solvent occurs, so that dots are formed in a short time. As a result, aggregation and color bleeding are prevented. However, even in the region of high-color density, dots maintain fixed shapes of them, whereby it may sometimes cause increased void formation. In the ink set of the present invention, by using in sets a high-temperature-gelling ink together with other ink than the high-temperature-gelling ink but has the same color hue as the high-temperature-gelling ink, occurrence of such voids of dots can be prevented whereby color density and image quality can be improved. In addition, such effect as prevention of color bleeding due to the high-temperature-gelling ink can be maintained.

### [High-Temperature Gelling Ink]

At least one kind of the inks of the present invention contains a heat-sensitive material to be hereinafter described and has a property of thickening (increasing of viscosity) in response to heating. The viscosity of the ink at 70° C. is preferably 100 mPa·s or more, and more preferably 150 mPa·s or more. The upper limit of the viscosity at 70° C. is not particularly restricted. A relatively higher viscosity is preferred. However, the viscosity is ordinarily 10,000 mPa·s or less. In addition, a measuring method of the viscosity in the present invention is as follows.

### (Measuring Method of Viscosity)

Unless otherwise indicated, the viscosity in the present invention refers to an average of the values obtained by measuring a viscosity five times every 100 seconds after the test sample has been adjusted to a predetermined temperature using a temperature-variable type rotational viscometer Physica MCR301 (trade name, manufactured by Anton Paar GmbH). It can be assumed that the viscosity obtained by the above measurement is also achieved on a recording sheet having been heated according to the recording method of the present invention described below. As the measuring conditions, shear rate of 10 (1/s) and rate of temperature rise of 5° C./5 seconds are used.

The thickening behavior of the high-temperature gelling ink is assumed as follows. The heat-sensitive material in the ink is a polymer that undergoes dissociative resolution and associative thickening at a given transition temperature. When the polymer is dissolved in a medium by hydration, the polymer dehydrates by heating. As a result, the polymer molecules interact with each other whereby the ink turns into a gel, resulting in thickening.

According to the ink set of the present invention, it is possible to suppress both aggregation and color bleeding of the ink droplets in a high-speed printing by using at least one kind of inks that have such properties.

Further, in the case of forming dots with such high-temperature gelling ink according to the ink jet recording method, a solvent evaporates after increase of viscosity due to gel transition. As a result, the cross-sectional shape of the dot forms a trapezoid or concave. From the viewpoint of density uniformity, a trapezoid is preferred. In the ink of the present invention, the shape of the dots to be formed is excellent whereby print qualities are also improved.

### [Heat-Sensitive Material]

The high-temperature-gelling ink contains a heat-sensitive material that thickens by heating.

As one example of the heat-sensitive materials, a water-soluble cellulose ether compound is exemplified. Examples of the water-soluble cellulose ether compound used in the present invention include hydroxypropyl cellulose, hydroxypropyl methylcellulose, methylcellulose, and hydroxybutoxyl-modified methylcellulose/hydroxypropyl methylcellulose. As commercially available products of these compounds, for example, METHOCEL K100 LV, METHOCEL A-15C, or METHOCEL HB (all trade names, manufactured by The Dow Chemical Company) can be favorably used.

As another example of the heat-sensitive materials, a polymer having at least one polyethyleneoxide (PEO) block structure is exemplified. Specific examples of the polymer include polyethylene oxide, di-block polymer of polyethylene oxide-polypropylene oxide (PEO-PPO), di-block polymer of polyethylene oxide-polycaprolactone, di-block polymer of polyethylene oxide-polylactide, and tri-block copolymer of polyethylene oxide-poly propylene oxide-polyethylene oxide (PEO-PPO-PEO). A block polymer having a PEO moiety (unit) and a PPO moiety is preferred. Further, it is especially preferred to use an aqueous solution of a PEO-PPO-PEO tri-block copolymer. The copolymerization ratio is preferably in the range of from 10 to 100% by mass, more preferably from 40 to 100% by mass, and especially preferably from 60 to 90% by mass, in terms of the percentage by mass of PEO contained in the above-described polymer. The allocation of PEO allocated to both sides of the PEO block is not particularly limited. However, the allocation is preferably in the range of from 1:99 to 50:50, more preferably from 10:90 to 50:50, and still more preferably from 20:80 to 50:50.

The molecular weight of the above polymer is preferably from 1,000 to 100,000, more preferably from 8,000 to 30,000.

When described simply as a molecular weight in the present invention, the molecular weight means a number average molecular weight unless otherwise specified, and the molecular weight is a value measured by the following measuring method.

### (Measuring Method of Molecular Weight)

The molecular weight is measured using GPC (gel permeation chromatography) method, unless otherwise specified. The gel packed in the column used for GPC method is preferably a gel having an aromatic compound in the repeating unit, and examples thereof include a gel comprising a styrene-divinylbenzene copolymer. Two to six columns are preferably connected and used. The solvent used includes an ether-based solvent such as tetrahydrofuran, and an amide-based solvent such as N-methylpyrrolidinone, and an ether-based solvent such as tetrahydrofuran is preferred. The measurement is preferably performed at a solvent flow rate of 0.1 to 2 mL/min, most preferably from 0.5 to 1.5 mL/min. When the measurement is performed in this range, the measurement can be performed more efficiently without imposing a load on the apparatus. The measurement temperature is preferably from 10 to 50° C., and most preferably from 20 to 40° C.

The specific conditions for the measurement of molecular weight are shown below.

Apparatus: HLC-8220GPC (manufactured by TOSOH CORPORATION)

Detector: Differential refractometer (RI detector)

Precolumn: TSK GUARD COLUMN MP (XL), 6 mm×40 mm (manufactured by TOSOH CORPORATION)

Sample-side column: Two of the following column were directly connected (all manufactured by TOSOH CORPORATION).

TSK-GEL Multipore-HXL-M 7.8 mm×300 mm

Reference-side column: Same as the sample-side column

Thermostatic bath temperature: 40° C.

Moving phase: Tetrahydrofuran

Flow rate of sample-side moving phase: 1.0 mL/min

Flow rate of reference-side moving phase: 0.3 mL/min

Sample concentration: 0.1 mass %

Amount of sample injected: 100 μL

Data sampling time: 16 to 46 minutes after sample injection

Sampling pitch: 300 msec

Examples of the aqueous solution of the tri-block copolymer of PEO-PPO-PEO that may be preferably used include commercially available products marketed as NEWPOL PE-78 (trade name, manufactured by Sanyo Chemical Industries, Ltd.), PLURONIC P85 (trade name, manufactured by BASF Corporation), NEWPOL PE-62 (trade name, manufactured by Sanyo Chemical Industries, Ltd.), NEWPOL PE-64 (trade name, manufactured by Sanyo Chemical Industries, Ltd.), NEWPOL PE-68 (trade name, manufactured by Sanyo Chemical Industries, Ltd.), NEWPOL PE-74 (trade name, manufactured by Sanyo Chemical Industries, Ltd.), NEWPOL PE-75 (trade name, manufactured by Sanyo Chemical Industries, Ltd.), NEWPOL PE-108 (trade name, manufactured by Sanyo Chemical Industries, Ltd.), NEWPOL PE-128 (trade name, manufactured by Sanyo Chemical Industries, Ltd.), PLURONIC L62 (trade name, manufactured by BASF Corporation), PLURONIC F87 (trade name, manufactured by BASF Corporation), and polyethylene glycol-block polypropylene glycol-block polyethylene glycol (manufactured by Aldrich Corporation).

The addition amount of the heat-sensitive material is not particularly limited, as long as a thickening effect due to heating (the viscosity of the ink at 70° C. satisfies the above predetermined value) is sufficiently obtained and the tri-block copolymer achieves viscosity such that the ink is ejected from a head of the recording apparatus. However, the heat-sensitive material is added in the range of preferably from 2% by mass to 20% by mass, and more preferably from 5% by mass to 15% by mass. If the addition amount is too small, a thickening effect sometimes may not be sufficiently obtained. On the other hand, if the addition amount is too large, ink viscosity before heating becomes too high, so that ejection of the ink from a head of the recording apparatus sometimes may be affected.

Further, two or more kinds of heat-sensitive materials may be used in combination in the present invention. In this case, it is preferred to set a total content of the heat-sensitive material within the above-described range.

Further, it is preferred that the heat-sensitive material used in the present invention exists in the ink in a solution state.

### [Normal Ink]

In the ink set of the present invention, at least one ink which has viscosity at 70° C. of 30 mPa·s or less, and preferably in the range of from 2 to 20 mPa·s is used in sets with a high-temperature-gelling ink at least in one color hue. In this ink, a thickening effect due to heating is suppressed by nonuse of heat-sensitive material or by reducing the content of the heat-sensitive material in the ink to 1% by mass.

In addition, with respect to the inks used in the ink set of the present invention, the high-temperature-gelling ink and other inks each have viscosity at 25° C. of preferably 10 mPa·s or less, and more preferably in the range of from 2 to 8 mPa·s. If the viscosity is in the above-described range, ejectability of ink from an ink jet head can be successfully controlled.

The ink composition other than the heat-sensitive material is common in both the high-temperature-gelling ink and other inks. Accordingly, these inks will be collectively explained below.

### [Pigment]

As the pigment in the present invention, any known pigment can be used without any particular restriction. Above all, a pigment that is substantially insoluble or sparingly soluble in water is preferred from the standpoint of ink coloring properties. In the present invention, a water-insoluble pigment itself or a pigment itself surface-treated with a dispersant can be used as the pigment (colorant).

The pigment that may be used in the present invention is not particularly limited in its kind, and any one of the conventional organic and inorganic pigments may be used. Examples of the pigment that may be used include polycyclic pigments such as azo lake, azo pigment, phthalocyanine pigment, perylene and perynone pigments, anthraquinone pigment, quinacridone pigment, dioxadine pigment, diketopyrrolopyrrole pigment, thioindigo pigment, isoindolinone pigment and quinophthalone pigment; dye lakes such as basic dye type lake and acidic dye type lake; organic pigments such as nitro pigment, nitroso pigment, aniline black and daylight fluorescent pigment; and inorganic pigments such as titanium oxide, iron oxide type and carbon black type. Even pigments that are not described in Color Index can be used so long as they are pigments capable of being dispersed in an aqueous phase. Furthermore, those obtained by surface-treating the above-described pigments with a surfactant, a polymeric dispersant or the like, and grafted carbon can also be used. Of the above pigments, azo pigment, phthalocyanine pigment, anthraquinone pigment, quinacridone pigment and carbon black type pigment are preferably used. For black pigments, it is especially preferred to use carbon black type pigments.

Specific examples of the organic pigment used in the present invention are described below.

Examples of the organic pigment for orange or yellow include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180 and C.I. Pigment Yellow 185.

Examples of the organic pigment for magenta or red include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and C.I. Pigment Violet 19.

Examples of the organic pigment for green or cyan include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Green 7, and siloxane-crosslinked aluminum phthalocyanine described in U.S. Pat. No. 4,311,775.

Examples of the organic pigment for black include C.I. Pigment Black 1, C.I. Pigment Black 6 and C.I. Pigment Black 7.

The average particle diameter of the pigment is preferably from 10 to 200 nm, more preferably from 10 to 150 nm, and further preferably from 10 to 100 nm. When the average particle diameter is 200 nm or less, favorable color reproducibility and dotting properties upon dotting by an ink jet method can be achieved. When the average diameter is 10 nm or more, favorable light fastness can be achieved. The particle size distribution of the pigment is not particularly limited, and the pigment may have a wide range of particle size distribution or a monodispersible particle size distribution. Further, two or more kinds of pigment each having a monodispersible particle size distribution may be used in combination.

The average particle diameter and the particle size distribution of the pigment can be obtained by measuring the volume-average particle diameter of the pigment by a dynamic light scattering method, using a NANOTRACK particle size distribution analyzer (UPA-EX150, trade name, manufactured by Nikkiso Co., Ltd.).

The pigment may be used alone or in combination of two or more kinds. From the viewpoint of image density, the content of pigment in the ink is preferably from 1% by mass to 25% by mass, more preferably from 2% by mass to 20% by mass, still more preferably from 5% by mass to 20% by mass, and particularly preferably from 5% by mass to 15% by mass, with respect to the total amount of the ink composition.

### [Dispersant and Dispersion Medium]

Ordinarily the dispersant is a material to be added for the purpose of dispersing a pigment, and the dispersing medium (binder) is a material to be added for the purpose of improving scratch resistance, solvent resistance, water resistance, and the like. However, in the present invention, a material that is described bellow as the dispersant may be added as a dispersing medium. Accordingly, the dispersant and the dispersing medium are collectively explained below as a dispersant.

The pigment according to the present invention is preferably dispersed in an aqueous solvent by a dispersant. The dispersant may be a polymer dispersant, or a surfactant-type dispersant. The polymer dispersant may be either one of a water-soluble dispersant or a water-insoluble dispersant.

The above surfactant-type dispersant can be added for the purpose of dispersing an organic pigment stably in an aqueous medium while maintaining the viscosity of the ink at a low level. The surfactant-type dispersant referred to herein is a dispersant of which molecular weight is smaller than that of the polymer dispersant, and the surfactant-type dispersant has a mass average molecular weight of 2,000 or less. The molecular weight of the surfactant-type dispersant is preferably from 100 to 2,000, and more preferably from 200 to 2,000.

As the water-soluble dispersant among the polymer dispersant in the present invention, a hydrophilic polymer compound can be used. Examples of natural hydrophilic polymer compounds include plant polymers such as gum arabic, gum tragacanth, guar gum, gum karaya, locust bean gum, arabinogalactan, pectin and quince seed starch, algae polymers such as alginic acid, carrageenan and agar, animal polymers such as gelatin, casein, albumin and collagen, and microbial polymers such as xanthene gum and dextran.

Examples of hydrophilic polymer compounds obtained by chemically modifying natural raw materials include cellulose polymers such as methyl cellulose, ethyl cellulose, hydroxyethyl cellulose, hydroxypropyl cellulose and carboxymethyl cellulose, starch polymers such as sodium starch glycolate, and sodium starch phosphate, and algae polymers such as propylene glycol alginate.

Examples of synthetic water-soluble polymer compounds include vinyl polymers such as polyvinyl alcohol, polyvinyl pyrrolidone and polyvinyl methyl ether; acrylic resins such as polyacrylamide, polyacrylic acid and alkali metal salts thereof, or water-soluble styrene acrylic resin; water-soluble styrene maleic acid resin; water-soluble vinylnaphthalene acrylic resin; water-soluble vinylnaphthalene maleic acid resins; polyvinyl pyrrolidone; polyvinyl alcohol; alkali metal salts of formalin condensates of β-naphthalene sulfonic acid; polymer compounds having, at a side chain, a salt of a cationic functional group such as a quaternary ammonium group or an amino group.

Among these, a polymer compound containing a carboxyl group or a sulfonyl group is preferable from the viewpoint of dispersion stability of pigment. Polymer compounds containing a carboxyl group such as the following are particularly preferable: (meth)acrylic resins such as styrene-(meth)acrylic resins; styrene maleic acid resins; vinylnaphthalene acrylic resins; vinylnaphthalene maleic acid resins, polyvinylbenzenesulfonate resins, polystyrene-vinylbenzenesulfonate resins, and styrene-vinylsulfonate resins.

The mass average molecular weight of the polymer dispersant in the present invention is preferably from 3,000 to 200,000, more preferably from 5,000 to 100,000, further preferably from 5,000 to 80,000, and still further preferably from 10,000 to 60,000.

The ratio of an amount of the pigment to an amount of the dispersant (pigment: dispersant) in the ink composition in terms of mass is preferably in the range of from 1:0.06 to 1:3, more preferably in the range of from 1:0.125 to 1:2, and still more preferably in the range of from 1:0.125 to 1:1.5.

### [Solvent]

The ink of the present invention is an aqueous ink. As the solvent, water, more preferably ion-exchanged water is used. Any other organic solvent may be contained for the purpose of suppressing drying, accelerating penetration, regulating viscosity, and the like.

A certain organic solvent used as an anti-drying agent can effectively prevent nozzle clogging, which could otherwise be caused by the ink dried in the ink ejecting port in the process of ejecting the ink composition by ink-jet method for image recording.

For the suppression of drying, a hydrophilic organic solvent having a vapor pressure lower than that of water is preferably used. Specific examples of the hydrophilic organic solvent suitable for the suppression of drying include: polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, and trimethylolpropane; heterocyclic compounds such as 2-pyrrolidone, N-methyl-2-pyrrolidone, 1,3-dimethyl-2-imidazolidinone, and N-ethylmorpholine; sulfur-containing compounds such as sulfolane, dimethylsulfoxide and 3-sulfolene; polyfunctional compounds such as diacetone alcohol and diethanolamine; and urea derivatives. Among these, polyhydric alcohols such as glycerin and diethylene glycol are preferred.

In order to accelerate the penetration, an organic solvent may be used for better penetration of the ink composition into a recording media. Examples of the organic solvent suitable for accelerating the penetration include alcohols such as ethanol, isopropanol, butanol, and 1,2-hexanediol, sodium lauryl sulfate, sodium oleate, and nonionic surfactants.

In addition to the above purposes, the hydrophilic organic solvent may also be used to control viscosity. Specific examples of the hydrophilic organic solvent that may be used to control viscosity include alcohols (e.g., methanol, ethanol and propanol), amines (e.g., ethanolamine, diethanolamine, triethanolamine, ethylenediamine, and diethylenetriamine), and other polar solvents (e.g., formamide, N,N-dimethylformamide, N,N-dimethylacetamide, dimethylsulfoxide, sulfolane, 2-pyrrolidone, acetonitrile, and acetone).

The content of the organic solvent is preferably from 0% by mass to 80% by mass, more preferably from 0% by mass to 60% by mass, and still more preferably from 0% by mass to 50% by mass with respect to the total amount of the ink.

### [Water]

The ink used in the present invention contains water. There is no particular limitation to the content of water in the ink. The content of water may be from 10% by mass to 99% by mass, more preferably from 30% by mass to 80% by mass, and still more preferably 50% by mass to 70% by mass with respect to the total amount of the ink.

### [Other Additives]

The ink composition of the invention may further contain other additives in accordance with necessity. Examples of such other additives include known additives such as a color fading inhibitor, an emulsion stabilizer, a permeation accelerator, an ultraviolet absorbent, a preservative, a mildew-proofing agent, a pH regulator, a surface tension regulator, a defoaming agent, a viscosity-adjusting agent, a dispersant, a dispersion stabilizer, an anti-rust agent and a chelating agent. These various additives may directly be added after preparation of the ink composition, or may be added at the time of preparation of the ink composition.

### [Ultraviolet Absorbent]

The ultraviolet absorbent is used for the purpose of improving preservability of an image. As the ultraviolet absorbent, the following compounds can be used; benzotriazole compounds described in, for example, JP-A-58-185677, JP-A-61-190537, JP-A-2-782, JP-A-5-197075 and JP-A-9-34057; benzophenone compounds described in, for example, JP-A-46-2784 and JP-A-5-194483, and U.S. Pat. No. 3,214,463; cinnamic acid compounds described in, for example, JP-B-48-30492 (“JP-B” means examined Japanese patent publication) and JP-B-56-21141, and JP-A-10-88106; triazine compounds described in, for example, JP-A-4-298503, JP-A-8-53427, JP-A-8-239368 JP-A-10-182621, and JP-T-8-501291 (“JP-T” means published Japanese translation of PCT application); compounds described in Research Disclosure No. 24239; and compounds that absorb ultraviolet light and emit fluorescence, i.e., fluorescent brighteners, typified by stilbene compounds or benzoxazole compounds.

### [Color Fading Inhibitor]

The color fading inhibitor is used for the purpose of improving storability of an image. Examples of the color fading inhibitor that can be used include various organic color fading inhibitors and metal complex color fading inhibitors. Examples of the organic color fading inhibitor include hydroquinones, alkoxyphenols, dialkoxyphenols, phenols, anilines, amines, indanes, chromanes, alkoxyanilines and heterocycles. Examples of the metal complex color fading inhibitor include a nickel complex and a zinc complex. More specifically, compounds described in the patents cited in Research Disclosure No. 17643, chapter VII, items I to J; Research Disclosure No. 15162: Research Disclosure No. 18716, page 650, the left-hand column; Research Disclosure No. 36544, page 527; Research Disclosure No. 307105, page 872; and Research Disclosure No. 15162, and compounds included in the formulae of the representative compounds and the exemplified compounds described on pages 127 to 137 of JP-A-62-215272 can be used.

### [Mildew-Proofing Agent]

Examples of the mildew-proofing agent include sodium dehydroacetate, sodium benzoate, sodium pyridinethion-1-oxide, p-hydroxybenzoic acid ethyl ester, 1,2-benzisothiazolin-3-one and its salt. These are preferably used in the ink composition in an amount of from 0.02 to 1.00% by mass.

### [pH Regulator]

As the pH regulator, a neutralizer (organic base and inorganic alkali) may be used. The pH regulator may be added in an amount such that the ink composition has pH of preferably from 6 to 10, and more preferably from 7 to 10, from the view point of improving storage stability of the ink composition.

### [Surface Tension Regulator]

Examples of the surface tension regulator include nonionic surfactants, cationic surfactants, anionic surfactants, and betaine type surfactants.

For smooth ejection in the ink jet recording method, the amount of addition of the surface tension regulator is preferably such that the surface tension of the ink composition can be adjusted in the range of from 20 mN/m to 60 mN/m, more preferably from 20 mN/m to 45 mN/m, further preferably from 25 mN/m to 40 mN/m. When the ink is applied by methods other than ink jet methods, the amount of addition of the surface tension regulator is preferably such that the surface tension of the ink composition can be adjusted in the range of from 20 mN/m to 60 mN/m, more preferably from 30 mN/m to 50 mN/m.

The surface tension of the ink composition may be measured by a plate method using Automatic Surface Tensiometer CBVP-Z (trade name, manufactured by Kyowa Interface Science Co., LTD.) under the temperature condition of 25° C.

### [Surfactant]

Specific examples of the hydrocarbon-series surfactant include anionic surfactants such as fatty acid salts, alkyl sulfate ester salts, alkyl benzenesulfonates, alkyl naphthalenesulfonates, dialkyl sulfosuccinates, alkyl phosphate ester salts, naphthalenesulfonic acid-formalin condensates, and polyoxyethylene alkyl sulfate ester salts; and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkylamines, glycerin fatty acid esters, and oxyethylene-oxypropylene block copolymers. Acetylene polyoxyethylene oxide surfactants SURFYNOLs (trade name, manufactured by Air Products & Chemicals, Inc.) are also preferably used. Amine oxide type amphoteric surfactants such as N,N-dimethyl-N-alkylamine oxide are also preferable.

The surfactants listed in pages 37 to 38 of JP-A-59-157636 and Research Disclosure No. 308119 (1989) may also be used.

Fluorocarbon (alkyl fluoride type) surfactants or silicone surfactants as described in JP-A-2003-322926, JP-A-2004-325707 and JP-A-2004-309806 may be used to improve a scratch resistance.

The surface tension regulator may also be used as a defoaming agent, and fluorine-series compounds, silicone-series compounds, and chelating agents as typified by EDTA may also be used.

In the ink of the present invention, a thickener, a conductivity improver, a kogation inhibitor (“kogation” means solid deposits baked onto the surface of a heater), a desiccant, a water-resistant ruggedization agent, a light stabilizer, a buffering agent, an anti-curling agent, or the like further may be added. Examples of the buffering agent include sodium borate, sodium hydrogenphosphate, sodium dihydrogenphosphate, and a mixture thereof. However, the buffering agent is not limited thereto.

Next, the ink jet recording method of the present invention will be described.

### [Ink-Jet Recording Method]

The ink-jet recording method is a method to form images by ejecting ink droplets from a plurality of nozzles or orifices built in a recording head of an ink-jet printer, and allowing the ink droplets to land on a recording sheet while controlling the ink droplets by the ejection. This method is roughly classified into a method of ejecting liquid droplets by applying a mechanical energy to the liquid droplets and a method of ejecting liquid droplets by bubble release resulting from application of heat energy to the liquid droplets. In the present invention, any one of these methods may be used. A piezo-type recording head is preferably used. If a thermal type head is used, an ink may thicken due to heat at the time of ejecting the ink. As a result, the ejection direction or ejection amount of the ink may become unstable. In some cases, ejection may become impossible. In contrast, use of the piezo head makes it possible to eject the ink very well, so the piezo head is preferable.

The printing speed is not particularly limited. However, since the present invention makes it possible to obtain excellent images even in a high-speed printing, the range of from 50 in/min to 200 m/min is preferred. Though the liquid amount per droplet is not particularly limited, the range of from 2 to 15 pl is preferred.

In the ink jet recording method of the present invention, image formation is performed by ejecting ink droplets from a recording head. In addition, the ink-jet recording method of the present invention is characterized in that the recording sheet is heated to 70° C. or higher before the ink droplets land, or at the time of landing, preferably in the range of from 70° C. to 100° C., more preferably in the range of from 70° C. to 90° C., and still more preferably in the range of from 70° C. to 80° C. This temperature is defined as a value obtained by measuring a temperature at the side of the ink jet recording (the side at which ink droplets land) of the recording sheet using a noncontact thermometer such as an infrared thermometer (for example, IR-66B (trade name), manufactured by MK Scientific, Inc.). The measuring position is set between a head section of the ink-jet recording apparatus and a means (unit) that heats a recording sheet. If the heating temperature is too low, the ink may not sufficiently thicken. Further, in order to heat to a higher temperature than the above-described temperature, extra heat sources are needed. As a result, the extra heat sources become a load on the system. In addition, heating may be carried out both before the ink droplets land and at the time of landing. In the method of the present invention, the thickening of the ink on a recording sheet is accelerated by heating on the recording sheet whereby, for example, bleeding can be suppressed.

The recording sheet to be used may be, but not limited to, a sheet of general printing paper (plain paper) containing cellulose as a main component, such as so-called high-quality paper, coated paper, or art paper. When general printing paper containing cellulose as a main component is used in image recording by a conventional ink-jet method with a water-based ink, the ink may be absorbed in the paper and dried relatively slowly, so that colorants in the ink may be likely to migrate after being provided on the paper, which may easily lead to image quality deterioration. According to the ink jet recording method of the invention, however, the migration of the colorants (pigments) may be suppressed so that high-quality image recording with good color density and suppression of penetration of the ink may be achieved.

Generally commercially available recording sheet may be used as the recording sheet, and examples thereof include high-quality paper (A) such as OK PRINCE HIGH-QUALITY (trade name, manufactured by Oji Paper Co., Ltd.), SHIORAI (trade name, manufactured by Nippon Paper Industries Co., Ltd.) and NEW NPI HIGH-QUALITY (trade name, manufactured by Nippon Paper Industries Co., Ltd.); lightly coated paper such as OK EVER LIGHT COAT (trade name, manufactured by Oji Paper Co., Ltd.) and AURORA S (trade name, manufactured by Nippon Paper Industries Co., Ltd.); lightweight coated paper (A3) such as OK COAT L (trade name, manufactured by Oji Paper Co., Ltd.) and AURORA L (trade name, manufactured by Nippon Paper Industries Co., Ltd.); coated paper (A2, B2) such as OK TOP COAT+ (trade name, manufactured by Oji Paper Co., Ltd.) and AURORA Coat (trade name, manufactured by Nippon Paper Industries Co., Ltd.); and art paper (A1) such as OK KANAFUJI+(trade name, manufactured by Oji Paper Co., Ltd.) and TOKUBISHI ART (trade name, manufactured by Mitsubishi Papers Mills Ltd.).

The present invention is contemplated for providing an ink jet recording ink set which can realize high-density and high-image quality printing in addition to suppression of penetration of the high-temperature-gelling ink through the paper. In addition, the present invention is contemplated for providing an ink jet recording method which can realize high-density and high-image quality printing in addition to suppression of penetration of the ink through the paper.

The ink set of the present invention, when used in a high-speed ink jet recording, exhibits excellent functional effects such that a high-density and high-image quality printing can be realized; and penetration of the ink through the paper is suppressed. Accordingly, the ink-jet recording method of the present invention that uses the above-described ink set makes it possible to suppress penetration of the ink through the paper and also to form a high-density and good-quality image in a high-speed print.

The present invention will be described in more detail based on the following examples, but the invention is not intended to be limited thereto. In the following examples, the terms “part(s)” and “%” are values by mass, unless otherwise specified.

In addition, the weight average molecular weight was measured by gel permeation chromatography (GPC). HLC-8220 GPC (trade name, manufactured by TOSOH CORPORATION) was used for the GPC, and TSK GEL Super HZM-H, TSK GEL Super HZ4000, and TSK GEL Super HZ2000 (trade names, all manufactured by TOSOH CORPORATION) were used as the columns and were connected in a series of three. THF (tetrahydrofuran) was used as the eluent solution. For the conditions, the sample concentration was 0.35% by mass, the flow rate was 0.35 mL/min, the amount of sample injection was 10 μL, the measurement temperature was 40° C., and an RI detector was used. A calibration curve was prepared from 8 samples of the “standard sample TSK standard, polystyrene”: “F-40”, “F-20”, “F-4”, “F-1”, “A-5000”, “A-2500”, “A-1000” and “n-propylbenzene” (trade names, manufactured by TOSOH CORPORATION).

### EXAMPLES

### Example 1

### Synthesis of Water-Insoluble Polymer Dispersant P-1

88 g of methyl ethyl ketone was added to a 1000-ml three-necked flask equipped with a stirrer and a condenser tube, and was heated to 72° C. under a nitrogen atmosphere. To this, a solution of 0.85 g of dimethyl 2,2′-azobisisobutyrate, 60 g of benzyl methacrylate, 10 g of methacrylic acid and 30 g of methyl methacrylate dissolved in 50 g of methyl ethyl ketone was added dropwise over a period of 3 hours. After the addition was completed, the mixture was reacted for additional one hour, and then a solution of 0.42 g of dimethyl 2,2′-azobisisobutyrate dissolved in 2 g of methyl ethyl ketone was added. The temperature was elevated to 78° C., and the mixture was heated for 4 hours. The obtained reaction solution was precipitated two times in large excess of hexane, and the precipitated resin was dried to obtain 96 g of a water-insoluble polymer dispersant P-1.

The composition of the obtained resin was confirmed by ¹H-NMR, and the weight average molecular weight (Mw) determined by GPC was 44,600. The acid value was determined by the method described in JIS Standards (JIS K0070: 1992), and the value was 65.2 mgKOH/g.

### —Preparation of Dispersion K of Resin-Coated Carbon Black Particles (Pigment Dispersion)—

Carbon black and other components were mixed according to the following composition and dispersed with a beads mill using 0.1 mm φ zirconia beads for 3 to 6 hours. From the resulting dispersion, the methyl ethyl ketone was removed at 55° C. under reduced pressure, and further, a part of the water was removed, whereby a dispersion of resin-coated carbon black particles having a carbon black concentration of 10.0% by mass was prepared.

### (Composition of Dispersion K of Resin-Coated Carbon Black Particles)

Carbon black (trade name: NIPEX 180-IQ, manufactured by Degussa; specific surface area by BET method: 260 m²/g) 10.0 parts
Water insoluble Polymer dispersant P-1 4.5 parts Methyl ethyl ketone (organic solvent) 30.5 parts
1 mol/L NaOH aqueous solution (neutralizing agent) 6.3 parts
Polyoxyethylene Lauryl Ether (nonionic surfactant, Emalgen 109 P (trade name), manufactured by KAO Corporation, HLB: 13.6) 0.1 part
Ion-exchanged water 98.6 parts

### (Particle Size Measurement of Resin-Coated Carbon Black Particles)

The resulting dispersion of resin-coated carbon black particles (pigment dispersion) was measured for its volume-average particle size by a dynamic light scattering method using a particle size distribution measuring instrument NANOTRAC UPA-EX 150 (trade name, manufactured by NIKKISO Co., Ltd.). In this measurement, 10 mL of ion-exchanged water was added to 30 μL of the resin-coated carbon black particle dispersion to prepare a measurement sample, and the thus prepared sample was then measured at a controlled temperature of 25° C. The obtained particle size was 98 nm.

### —Preparation of Aqueous Ink for Ink jet Recording—

Then, the resulting dispersion K of resin-coated carbon black particles was used to prepare an aqueous ink with the following composition. A plastic disposable syringe was filled with this aqueous ink, and then filtrated using a PVDF 5 μm filter Millex-SV (trade name, manufactured by Millipore Corporation, diameter: 25 mm). Thus, black ink (ink composition for ink-jet) K1 which gels at high temperature was obtained. The pH of the aqueous ink at 25° C. was 8.9.

### <Composition of Black ink K1>

Dispersion K of resin-coated carbon black particles 40.0 parts
NEWPOL PE-78 (PEO-PPO-PEO triblock polymer, manufactured by Sanyo Chemical Industries, Ltd., trade name) (Mn: 8700, containing PEO by 80% by mass) 9.0 parts
Urea (manufactured by Wako Pure Chemical Industries, Ltd.) 15.0 parts
Olfine E1010 (surfactant, manufactured by Nissin Chemical Industry Co., Ltd., trade name) 1.0 part
Ion-exchanged water 35.0 parts

Black ink K2 was prepared in the same manner as Black ink K1 except that the ink was changed to the following composition. The pH of the aqueous ink at 25° C. was 8.6.

### <Composition of Black ink K2>

Dispersion K of resin-coated carbon black particles 40.0 parts
Glycerin (manufactured by Wako Pure Chemical Industries, Ltd.) 33.0 parts
Diethylene glycol (manufactured by Wako Pure Chemical Industries, Ltd.) 10.0 parts
Olfine E1010 (surfactant, manufactured by Nissin Chemical Industry Co., Ltd., trade name) 1.0 part
Ion-exchanged water 16.0 parts

### (Evaluation of Viscosity)

Measurement of ink viscosity (m Pa·s) at each temperature shown in Table 1 ranging from 25° C. to 90° C. was conducted with respect to Black inks K1 and K2. The value of viscosity was defined as an average of the values obtained by measuring a viscosity five times every 100 seconds after the test sample has been adjusted to a predetermined temperature shown in Table 1 using a temperature-variable type rotational viscometer Physica MCR301 (trade name, manufactured by Anton Paar GmbH). As the measuring conditions, shear rate of 10 (1/s) and rate of temperature rise of 5° C./5 seconds were used. The results are shown in Table 1.

TABLE 1

| | Viscosity (mPa · s) | |
|---|---|---|
| | Black ink K1 | Black ink K2 |
| Temperature | (capability of gelling at high | (capability of gelling at high |
| (° C.) | temperature exists.) | temperature does not exist.) |
| 25 | 5.3 | 6.5 |
| 30 | 4.8 | 6.0 |
| 40 | 4.4 | 5.3 |
| 50 | 4.2 | 4.5 |
| 60 | 6.9 | 3.9 |
| 70 | 250.8 | 3.5 |
| 80 | 210.3 | 3.3 |
| 90 | 200.6 | 3.2 |

### —Recording of Image (Black)—

An ink set composed of Black ink K1 and Black ink K2 was prepared. Then, the Black ink K1 and the Black ink K2 were each filled in different piezoelectric heads (384 nozzles) and a print voltage was adjusted so that the ink droplet size fell within the range of from 7 to 8 pl. A normal paper NPi-55 (trade name, manufactured by Nippon Paper Industries Co., Ltd., basis weight: 55 g/m²) was set on a heater, and then heated so that the temperature on the plane of paper became 70° C. After that, by adjusting a quantity of ink from two heads, 1 cm×1 cm-size five-step images having halftone dot percentages of 100%, 80%, 60%, 40%, and 20% were printed in a single pass mode. The temperature on the plane of paper was measured using a radiation thermometer (trade name: IR-66B, manufactured by MK Scientific, Inc.). In addition, the printing condition is as follows.

### <Printing Condition>

Printing speed: 100 m/min

### Resolution: 600 dpi

Evaluation of the printed matters was conducted as follows.

### (Evaluation of Print Density)

The printed image density having a halftone dot percentage of 100% was measured using a reflected density meter (X-Rite 310 TR (trade name), manufactured by X-Rite, Inc.). Measurement was conducted in accordance with descriptions of Japan Color, and measurement was conducted by putting a black paper under the sample. Evaluation of printed density was conducted in terms of small or large of the visual density thus obtained. (The larger the value is, the better the evaluation is.)

### (Evaluation of Penetration of the Image Through the Paper)

The printed image portion having the halftone dot percentage of 100% was measured from the back side thereof using the above-described reflected density meter (X-Rite 310 TR). Evaluation of penetration of the image (ink) through the paper was conducted in terms of small or large of the measured value thus obtained. (The smaller the value is, the better the evaluation is.)

### (Granularity)

With respect to a feeling of roughness in the printed image portion having the halftone dot percentage of 20%, a sensory evaluation was conducted on the basis of the following criterion.

A: There is no feeling of roughness, and it is a very smooth image.
B: There is some feeling of roughness.
C: It is a very rough image.

The evaluation results are shown in Table 2.

TABLE 2

| | Comparative | | | | | | Comparative |
|---|---|---|---|---|---|---|---|
| | Example | Example | Example | Example | Example | Example | Example |
| | 1 | 1 | 2 | 3 | 4 | 5 | 2 |
| Use ratio of Black | 100% | 95% | 90% | 80% | 60% | 50% | 0% |
| ink K1 | | | | | | | |
| Use ratio of Black | 0% | 5% | 10% | 20% | 40% | 50% | 100% |
| ink K2 | | | | | | | |
| Print density | 0.81 | 0.86 | 0.94 | 0.97 | 0.89 | 0.83 | 0.75 |
| Penetration of the ink | 0.15 | 0.15 | 0.16 | 0.17 | 0.2 | 0.22 | 0.24 |
| through the paper | | | | | | | |
| Granularity | C | B | A | A | B | B | C |

(Remarks) In the case where Black inks K1 and K2 were used in combination, printing was conducted by controlling images so that each ink is ejected averagely.

From the results shown in Table 2, it is understood that a combination use of the ink which gels at high temperature and the ink which does not gel at high temperature makes it possible to form a high-print-density and smooth-image which is free from a feeling of roughness while maintaining the achievement of the degree of penetration of the ink through the paper that is almost equal to that achieved by using either one of the ink which gels at high temperature or the ink which does not gel at high temperature.

### (Preparation of Black Ink K3)

Black ink K3 which gels at high temperature was prepared in the same manner as Black ink K1, except that 9.0 parts of NEWPOL PE-78 as a heat-sensitive material in the Black ink K1 was substituted with 3.5 parts of METHOCEL (trade name, manufactured by The Dow Chemical company) and 5.5 parts of ion-exchanged water. The pH of ink K3 at 25° C. was 8.7, and the viscosity of ink K3 was 6.2 mPa·s at 25° C. and 242.3 mPa·s at 70° C. respectively. An ink set was prepared using the thus-obtained Black ink K3 together with Black ink K2 which does not gel at high temperature, and then print evaluation was conducted in the same manner as described above. The results shown in Table 3 were obtained.

TABLE 3

| | Comparative | | | | | | Comparative |
|---|---|---|---|---|---|---|---|
| | Example | Example | Example | Example | Example | Example | Example |
| | 3 | 6 | 7 | 8 | 9 | 10 | 4 |
| Use ratio of Black | 100% | 95% | 90% | 80% | 60% | 50% | 0% |
| ink K3 | | | | | | | |
| Use ratio of Black | 0% | 5% | 10% | 20% | 40% | 50% | 100% |
| ink K2 | | | | | | | |
| Print density | 0.81 | 0.84 | 0.95 | 0.96 | 0.87 | 0.83 | 0.75 |
| Penetration of the ink | | | | | | | |
| through the paper | 0.15 | 0.16 | 0.17 | 0.18 | 0.21 | 0.22 | 0.24 |
| Granularity | C | B | A | A | B | B | C |

From the results shown in Table 3, it is understood that the ink set composed of the ink which uses methylcellulose and gels at high temperature and the ink which does not gel at high temperature also makes it possible to form a high-print-density and smooth-image which is free from a feeling of roughness while maintaining the achievement of the degree of penetration of the ink through the paper that is almost equal to that achieved by using either one of the ink which gels at high temperature or the ink which does not gel at high temperature.

### Example 2

### Preparation of Dispersion C of Cyan Coloring Particles

10 parts of pigment blue 15:3 (trade name: PHTHALOCYANINE BLUE A220, manufactured by Dainichiseika Color & Chemicals Mfg. Co., Ltd; cyan pigment), 5 parts of the polymer dispersant P-1, 42 parts of methyl ethyl ketone, 5.5 parts of an aqueous 1N NaOH solution, and 87.2 parts of ion exchange water were mixed, and the mixture was dispersed for 2 to 6 hours by means of a beads mill using zirconia beads having a diameter of 0.1 mm.

From the obtained dispersion, methyl ethyl ketone was removed at 55° C. under reduced pressure, and further water was partially removed. Then, the resultant was subjected to centrifugal treatment using a 50 mL centrifuging tube by means of a HIGH-SPEED CENTRIFUGAL COOLER 7550 (trade name, manufactured by Kubota Corporation) at 8000 rpm for 30 minutes, thereby collecting the supernatant excluding the precipitate. Thereafter, the pigment concentration was determined from the absorbance spectrum, thereby obtaining a dispersion C of cyan coloring particles that is a dispersion of resin-coated pigment particles (pigment coated with a polymer dispersant) and has a pigment concentration of 10.2% by mass.

### —Preparation of Dispersion Y of Yellow Coloring Particles and Dispersion M of Magenta Coloring Particles—

Dispersion Y of yellow coloring particles and dispersion M of magenta coloring particles were prepared in the same manner as the above-described dispersion C of cyan coloring particles except that pigment blue 15:3 in the dispersion C of cyan coloring particles was changed to pigment yellow 74 (IRGALITE YELLOW GS, manufactured by Ciba Japan) and pigment red 122 (CROMOPHTAL JET MAGENTA, manufactured by Ciba Specialty Chemicals Inc.), respectively. The pigment densities of the dispersion Y of yellow coloring particles and the dispersion M of magenta coloring particles were 10.3% by mass and 10.1% by mass, respectively.

### (Measurement of Particle Diameters)

The particle diameters of the thus-obtained dispersion Y of yellow coloring particles, dispersion M of magenta coloring particles and dispersion C of cyan coloring particles were measured in the same manner as the dispersion K of carbon black particles. Results of measurement were as follows. Y: 115 nm, M: 105 nm, C: 97 nm

—Preparation of Color inks Y1, Y2, M1, M2, C1 and C2—

Inks Y1, M1 and C1 each of which gels at high temperature and Inks Y2, M2 and C2 each of which does not gel at high temperature were prepared in the same manner as in Example 1, except that the dispersion K of resin-coated carbon black particles in Example 1 was changed to the dispersion Y of yellow coloring particles, the dispersion M of magenta coloring particles and the dispersion C of cyan coloring particles, and an addition amount of each dispersion was adjusted so that the pigment density in each ink became 10.0% by mass. The pH and the viscosity of each ink at 25° C. and 70° C. are shown in Table 4.

TABLE 4

| | | Ink | | | | | | | |
|---|---|---|---|---|---|---|---|---|---|
| | | Y1 | Y2 | M1 | M2 | C1 | C2 | K1 | K2 |
| pH | | 8.7 | 8.4 | 8.6 | 8.4 | 8.9 | 8.4 | 8.9 | 8.6 |
| Viscosity | 25° C. | 5.4 | 6.0 | 5.5 | 6.1 | 5.2 | 5.9 | 5.3 | 6.5 |
| (mPa · s) | 70° C. | 210.6 | 3.1 | 230.1 | 3.4 | 220.4 | 3.2 | 250.8 | 3.5 |

—Recording of Image (color)—

Yellow inks Y1 and Y2, magenta inks M1 and M2 and cyan inks C1 and C2 were prepared in the same manner as in Example 1. Image evaluation of samples was conducted, one group of the samples being obtained by printing, while changing a use ratio of inks, the same monochromatic images as the images used in Example 1, except that ink sets composed of the two inks of each color were used; and another group of the samples being obtained by printing the monochromatic images only using either one of the two inks of each color. As a result, images having the equally high print density and good granularity as the Black ink were obtained by using two inks in combination with respect to each color.

### Example 3

### Full Color Image Recording

A full color image recording was carried out using the following ink sets A to E in accordance with the printing conditions under which the recording was carried out using the Black ink K1 and the Black ink K2 in Example 1. Then, sensory evaluation was conducted in terms of sharpness, penetration of the ink through the paper and smoothness of image. In addition, images were printed after selecting three kinds of each of portrait and scenic image. Further, in the case of ink sets A to C each using in combination of the ink which gels at high temperature and the ink which does not gel at high temperature, printing was carried out by adjusting the image so as to make the following combination ratio.

Ink which gels at high temperature: 80%

Ink which does not gel at high temperature: 20%

The evaluation criteria are as follows.

### (Sharpness)

A: The image has very high print density and high contrast, and the image is extremely sharp.
B: The image has high print density and high contrast.
C: In the image, there is a blurred feeling, and there is little sharpness.

### (Penetration)

A: There is no penetration of the ink through the paper.
B: There is almost no penetration of the ink through the paper, and there is no problem in practice.
C: There is some penetration of the ink through the paper, and it is a problematic level.
D: There is complete penetration of the ink through the paper, and it is not an acceptable level.

### (Smoothness of Image)

A: There is no feeling of roughness, and the image is very smooth.
B: There is some feeling of roughness.
C: The image is very rough.

The results are shown in Table 5.

TABLE 5

| | A | B | C | D | E |
|---|---|---|---|---|---|
| | Example | Example | Example | Comparative | Comparative |
| Ink set | 3-1 | 3-2 | 3-3 | Example 5 | Example 6 |
| Yellow Ink | Y1 | Y1 | Y1 | Y1 | Y1 |
| Magenta Ink | M1 | M1 | M1/M2 | M1 | M1 |
| Cyan Ink | C1 | C1/C2 | C1 | C1 | C1 |
| Black Ink | K1/K2 | K1/K2 | K1/K2 | K1 | K2 |
| Sharpness | A | A | A | B | C |
| Penetration of | B | B | B | A | D |
| the ink through | | | | | |
| the paper | | | | | |
| Smoothness | A | A | A | C | C |
| of image | | | | | |

In ink set E of Comparative Example, both sharpness and smoothness of image are not sufficient. In addition, there is penetration of the ink through the paper. In ink set D of Comparative Example, both sharpness and penetration of the ink through the paper are improved. However, smoothness of image is not sufficient.

In contrast, it is understood that use of ink sets A to C according to the present invention makes it possible to obtain a high-quality image having good sharpness and smoothness in addition to prevent penetration of the ink through the paper.

Having described our invention as related to the present embodiments, it is our intention that the present invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-062182 filed in Japan on Mar. 18, 2010, which is entirely herein incorporated by reference.

What we claim is:

1. An ink set, comprising:
at least one ink of which viscosity at 70° C. is 100 mPa·s or more; and
at least one ink of which color hue is the same as that of the above ink and of which viscosity at 70° C. is 30 mPa·s or less.

2. The ink set according to claim 1, wherein the ink of which viscosity at 70° C. is 100 mPa·s or more comprises a heat-sensitive material that gels at a high temperature.

3. The ink set according to claim 1, wherein the heat-sensitive material comprises a block polymer having an ethylene oxide moiety and a propylene oxide moiety.

4. The ink set according to claim 1, wherein the heat-sensitive material is a water-soluble cellulose ether compound.

5. The ink set according to claim 1, comprising:
at least an ink of which color hue is black and of which viscosity at 70° C. is 100 mPa·s or more; and
at least one ink of which color hue is black and of which viscosity at 70° C. is 30 mPa·s or less.

6. The ink set according to claim 5, wherein a carbon black-based pigment is used as the ink of which color hue is black.

7. An ink set, comprising:
at least one ink which thickens in response to heating; and
at least one ink of which color hue is the same as that of the said ink and which does not substantially thicken in response to heating.

8. The ink set according to claim 1, wherein a viscosity at 25° C. of each of inks in the ink set is 10 mPa·s or less.

9. The ink set according to claim 7, wherein the viscosity at 25° C. of each of inks in the ink set is 10 mPa·s or less.

10. The ink set according to claim 1, comprising at least a yellow hue ink, a magenta hue ink, a cyan hue ink, and a black hue ink.

11. The ink set according to claim 7, comprising at least a yellow hue ink, a magenta hue ink, a cyan hue ink, and a black hue ink.

12. An ink jet recording method, comprising the step of printing on a recording sheet by ejecting ink droplets from an orifice of a recording head in response to recording signals,
wherein the ink droplets are ejected from the recording head using the ink set according to claim 1, and
wherein the recording sheet is heated at 70° C. or higher before the ink droplets land on the recording sheet or at the time of landing thereof.

13. An ink-jet recording method, comprising the step of printing on a recording sheet by ejecting ink droplets from an orifice of a recording head in response to recording signals,
wherein the ink droplets are ejected from the recording head using the ink set according to claim 7, and
wherein the recording sheet is heated at 70° C. or higher before the ink droplets land on the recording sheet or at the time of landing thereof.

14. The ink-jet recording method according claim 12, wherein the recording head is of a piezo-type.

15. The ink-jet recording method according claim 13, wherein the recording head is of a piezo-type.
